(19) United States
(12) Patent Application Publication
(10) Pub. No.: US 2012/0032527 A1
(43) Pub. Date: Feb. 9, 2012

(54) THERMOGENERATOR ARRANGEMENT, THERMAL SWITCH, AND METHOD FOR OPERATING AN ELECTRICAL DEVICE

(75) Inventors: Martin Weidner, Muellheim-Zunzingen (DE); Manfred Mitreiter, Ebringen (DE); Thilo Lacoste, Ballrechten-Dottingen (DE); Joachim Nurnus, Neuenburg (DE); Axel Schubert, Muenchen (DE); Fritz Volkert, Oberwil (CH)

(73) Assignee: MICROPELT GMBH, Freiburg (DE)

(21) Appl. No.: 13/262,808

(22) PCT Filed: Mar. 31, 2010
(86) PCT No.: PCT/EP10/54329

§ 371 Date: Oct. 3, 2011

(30) Foreign Application Priority Data
Apr. 3, 2009 (DE) 10 2009 016 154.6

(51) Int. Cl. H01H 37/00

(52) U.S. Cl. 307/117

(57) ABSTRACT

A thermogenerator arrangement is provided. The thermogenerator arrangement comprising an electrically operable device, switching means by means of which the device can be switched from a first, energy-saving state to a second, active state and at least one thermogenerator which generates an electrical signal when there is a temperature change in its environment, which electrical signal is forwarded to the switching means. The switching means are formed such that switching the device from the first state to the second state is effected in dependence on the electrical signal of the thermogenerator.

### CROSS-REFERENCE TO A RELATED APPLICATION

This application is a National Phase Patent Application of International Patent Application Number PCT/EP2010/054329, filed on Mar. 31, 2010, which claims priority of German Patent Application Number 10 2009 016 154.6, filed on Apr. 3, 2009.

### BACKGROUND

This invention relates to a thermogenerator and a method for operating an electrical device.

By utilizing the Seebeck effect under the influence of a temperature gradient, thermogenerators generate an electric voltage which can be utilized e.g. for operating an electrical device (e.g. a measuring device).

### SUMMARY

The problem to be solved by the present invention consists in indicating a possibility for operating an electrical device by using a thermogenerator as energy-efficiently as possible.

According to an exemplary embodiment of the invention a thermogenerator arrangement is provided, comprising
an electrically operable device;
switching means by means of which the device can be switched from a first, energy-saving state to a second, active state; and
at least one thermogenerator which generates an electrical signal when there is a temperature change in its environment, which electrical signal is forwarded to the switching means, wherein
the switching means are formed such that switching the device from the first, energy-saving state to the second, active state is effected in dependence on the electrical signal of the thermogenerator.

As already mentioned above, a thermogenerator is a component which generates an electric voltage by utilizing the Seebeck effect under the influence of a temperature gradient. To ensure that in the case of a change in temperature, i.e. a temperature increase or reduction, in the environment of the thermogenerator a sufficient temperature gradient acts on the thermogenerator, in particular structures of different thermal capacity (thermal mass) are provided on its warm side and its cold side.

When there is a change in temperature in the environment, the temperature of the thermally more inert structure with the higher thermal capacity will change more slowly than the temperature of the structure with the lower thermal capacity. Due to the different thermal response behavior of the warm and cold sides of the thermogenerator realized in this way, a temperature gradient will be obtained when a change in temperature occurs in its environment. For example, structures of different materials, which have different specific thermal capacities and/or a different mass, can be provided on the cold and warm sides of the thermogenerator.

The thermogenerator in particular operates in an energy-autarkical manner, i.e. it does not require an energy source for operation, but it is a purely passive component which only generates a voltage upon occurrence of a temperature gradient. The electrically operable device, on the other hand, in particular is operated via a voltage source separate from the thermogenerator (e.g. fixed-network source or battery), i.e. in its second, active state the device at least chiefly obtains the electric energy necessary for operation from the separate voltage source. It can, however, be provided that in its active state the device is additionally or exclusively supplied with the voltage delivered by the thermogenerator.

Via the switching means, the electrically operable device can be switched from its first, energy-saving state to the second, active state, e.g. be “woken up” from a state of rest. “Energy-saving” means that in its first state the device consumes less electric energy than in the second state, wherein “first, energy-saving state” for example is also understood to be an off-state or a stand-by state of the device. In addition, the switching means also can serve to switch the device from the active state to the energy-saving state.

In addition, the switching means in particular are formed such that they only switch the device between the first and the second state when the amount of the electrical signal forwarded to them by the thermogenerator (i.e. the electric voltage forwarded to them) exceeds a specifiable threshold value.

The switching means in particular are realized in the form of an electronic circuit and/or a program code which is executed on a programmable unit. For example, the switching means are part of the electrically operable device.

In one exemplary aspect of the invention the thermogenerator, the switching means and the device form a unit, for example these components are integrated in a common housing or at least arranged on a common carrier.

The electrically operable device for example is a danger detector, which draws attention to imminent or acute danger situations, e.g. by generating an alarm signal. In particular, the danger detector is a fire detector and/or a burglar detector. These variants of the invention will be discussed below.

Furthermore, the electrically operable device can comprise an air pressure sensor, an air humidity sensor, a temperature sensor, one or more gas sensors and/or a microprocessor. Of course, however, the invention is not limited to a certain type of device, and beside those mentioned above any other electrically operable devices are conceivable in principle, which in dependence on the thermogenerator voltage are switched from an energy-saving state to an operating state. For example, the device itself might also be a temperature detection unit.

In one exemplary aspect of the invention, the thermogenerator is thermally connected (in particular via its warm or cold side) with a structure for absorbing body heat, in particular for laying on a hand portion (e.g. a finger) and is formed such that as a result of the change in temperature occurring in its environment when the hand portion is laid on the structure, it generates an electric voltage which switches the device from the first state to the second state by means of the switching means. In this aspect, the thermogenerator thus is configured as a manually operable thermal switch. Such a switch could of course be operated not only with a hand portion, but in principle also with other regions of the human body.

For example, the structure for laying on the finger can be made of copper or an other metal with good thermal conductivity, which e.g. is thermally connected with a warm side of the thermogenerator. On the cold side of the thermogenerator, a heat sink (for instance in the form of a cooling element) for example is provided, so that when laying on the finger, a temperature gradient as large as possible is obtained in the region of the thermogenerator.

In an exemplary development of this variant, the thermogenerator and the structure for laying on a hand portion are integrated into a door handle. For example, forwarding the signal of the thermogenerator to the electrically operable device to be controlled (for example one or more sockets or light sources) is effected by radio.

In general, it is possible that forwarding the electrical signal of the thermogenerator to the switching means is effected wirelessly. However, it is of course also possible that this connection is made via an electric line.

As mentioned above, the electrically operable device is formed e.g. for generating an (in particular electric, acoustic and/or optical) alarm and/or control signal, which is triggered in response to the electrical signal of the thermogenerator. In this variant of the invention, the thermogenerator represents a detector, so to speak, which monitors its environment for a change in temperature and forwards an electrical signal to the alarm device when such change in temperature occurs. Before triggering an alarm signal, the device is in its first, passive state and is put into the second, active state by the signal of the thermogenerator, in which second state it e.g. first of all checks whether the signal provided by the thermogenerator exceeds a specifiable threshold value. In dependence on this check, the device itself then for example generates an acoustic and/or optical alarm signal or sends a corresponding control signal to a signal transmitter and/or to an alarm center.

It is also conceivable that in response to a signal of the thermogenerator the alarm device first activates an (energy-consuming) measurement by means of a further sensor and only triggers an alarm signal in dependence on the result of this measurement. Applications include e.g. the monitoring of cooling or heating means, of a room temperature and in particular the fire protection, which will be discussed in detail below.

For using the thermogenerator arrangement according to the invention in fire protection, the electrically operable device comprises a fire detector for triggering an alarm signal. The thermogenerator should be formed and arranged such that in case of a fire in its environment it generates an electrical signal, wherein the switching means switch the fire detector from the first state to the second, active state in dependence on the electrical signal of the thermogenerator. In this exemplary embodiment of the invention, the thermogenerator thus has the function of a fire detector, which in particular responds to a rapid increase in temperature in its environment.

The second, active state (alarm state), into which the fire detector is put in case of a corresponding signal of the thermogenerator, does not necessarily mean that a human-perceptible alarm signal is generated immediately. Rather, the second state of the fire detector initially can also consist in that it activates one or more further detectors, which check whether a fire has broken out in the environment of the fire detector.

A light signal or an acoustic signal, for example, will only be generated upon confirmation by this additional detector, for example by the fire detector itself or by a separate signal transmitter, which receives an electrical alarm signal from the fire detector. It is of course also conceivable that after detection of a fire also by the additional detector the fire detector sends a communication signal (by line or by radio) to a fire alarm center, which thereupon generates an alarm signal. This alarm signal in particular is an optical/acoustic signal, an electrical signal to a signal transmitter and/or a communication signal to a rescue center (e.g. fire brigade).

The fire detector in particular includes an energy source (for example in the form of a battery) separate from the thermogenerator, which supplies the fire detector with electric energy. It is also conceivable that in the second state the fire detector additionally or exclusively is operated by the electric energy generated by the thermogenerator. In particular, the electric energy generated by the thermogenerator can be utilized to generate the human-perceptible alarm signal already mentioned above, to generate a corresponding control signal for triggering a human-perceptible alarm signal and forward the same to a signal transmitter (or to a central control station) and/or to activate further fire indicators of the fire detector.

In one exemplary development of this variant of the invention, the fire detector—as already mentioned above—includes additional means for detecting a fire, i.e. beside the thermogenerator used as fire detector further means are provided for detecting a fire. It thus is possible, for example, to also safely detect fires which are accompanied by an only slow increase in temperature (smoldering fires).

In particular, the means for detecting a fire are activated at intervals via activating means for triggering (carrying out) a measurement with which it can be detected whether a fire exists in the vicinity of the fire detector, wherein the time distance of the measurements triggered at intervals is chosen relatively large as compared to conventional fire detectors, in order to keep the energy consumption of the fire detector as low as possible. This is possible because flame fires, which result in a fast change in temperature, are detected by means of the thermogenerator and the additional means for detecting a fire merely serve for detecting slowly developing smoldering fires and otherwise only are activated in the second state of the fire detector, i.e. after a signal has arrived from the thermogenerator, in order to verify the presence of a fire. For example, the interval between two measurements which are carried out by the means for detecting the fire after being triggered by the activating means is at least 5 seconds, at least 10 seconds, at least 30 seconds, or at least 60 seconds. In conventional fire detectors, the detectors are activated for example every 2 s, in order to be able to also detect rapidly developing flame fires.

The means for detecting a fire for example comprise a smoke sensor (for example a scattered light sensor, a transmitted light sensor and/or a ionization sensor) and/or a fire gas sensor. In addition, a temperature sensor element different from the thermogenerator might also be present, which in particular allows a measurement of the absolute temperature. In principle, the fire detector can additionally include any known detectors, for example also infrared or ultraviolet detectors, which detect an increase in temperature or a flicker frequency of the fire flame. A video camera might also be used as fire detector. If the fire detector includes an additional temperature sensor for measuring the absolute ambient temperature, a temperature measurement can be carried out for example parallel to a scattered light measurement and an alarm can be triggered at a temperature lying above a specifiable threshold. In addition, the temperature measurements can be stored and compared with each other, so that even slow rises in temperature can be detected in the case of a smoldering fire.

The arrangement of thermogenerator and fire detector in particular can be tested by means of test gas, since the thermogenerator also registers a decrease in temperature due to the expansion of the gas and/or the occurring evaporation cold. If an optical sensor is present in addition, the same would then be activated for example by the change in temperature occurring at the thermogenerator.

In particular, the thermogenerator, the switching means and the fire detector form a common unit, for example they are arranged in a common housing and/or on a common carrier.

In addition, as already mentioned above, it is also conceivable that the electrically operable device is a burglar alarm system; e.g. also in combination with the fire detector described above. For example, the device here includes a body sound sensor which by means of the switching means (i.e. in response to a signal of the thermogenerator) can be switched from a passive to an active state.

For example, the body sound sensor can be arranged on a door (for example a safe door) or a window such that heat produced during an attempted burglary (for example when drilling or sawing into the door or window) causes an electrical signal of the thermogenerator which “wakes up” the body sound detector (or another sensor of the burglar alarm system) from an energy-saving, passive state.

The thermogenerator in particular is a microtechnologically (by thin-film technique) manufactured component, although the invention is not limited to this type of thermogenerator.

Furthermore, an electronic circuit can be provided, which amplifies the electrical signal generated by the thermogenerator. For example, this circuit includes at least one transistor, in particular a field-effect transistor. The circuit can also be part of the switching means. It is, however, also possible to supply the thermogenerator voltage to the device without preceding amplifier or other electronic editing circuitry.

A thermal switch can include a thermogenerator which generates an electrical signal under the influence of a temperature gradient and whose cold side and/or warm side is thermally connected with a phase change material. A phase change material has the capacity to absorb heat by a phase transition, for example latent heat which is required for a transition of the material from one state of matter to an other, in particular from the solid to the liquid state. Examples for phase change materials are organic materials (e.g. sugar alcohols, paraffin waxes), salt solutions or salt hydrates.

Furthermore, an exemplary embodiment of the invention relates to a method for operating an electrical device, with the following steps:
providing a thermogenerator which generates an electrical signal when there is a temperature change in its environment;
switching the electrical device into an energy-saving first state;
switching the electrical device from the first state to a second state in dependence on the electrical signal of the thermogenerator.

### BRIEF DESCRIPTION OF THE DRAWINGS

The invention will subsequently be explained in detail by means of an exemplary embodiment with reference to the FIGURE.

### DETAILED DESCRIPTION

The FIGURE shows a thermogenerator arrangement with an electrically operable device in the form of a microcontroller 1 which includes switching means in the form of a program code stored in the microcontroller, which can switch the same from an active (second) state to an energy-saving first state or vice versa.

Furthermore, the thermogenerator arrangement includes an in particular microtechnologically manufactured thermogenerator 2 which is electrically connected with an interrupt port 11 of the microcontroller 1, which is monitored by the program of the switching means.

On one side (for example the warm side) of the thermogenerator 2 a structure is provided in the form of a copper plate 3 for laying a finger (or other hand portion) on the same. On the opposite side (cold side) of the thermogenerator 2 a heat sink is provided, for example in the form of cooling fins. When laying a finger on the copper plate 3, a temperature gradient is obtained between the same and the heat sink 4, which acts on the thermogenerator 2, whereby an electric voltage is obtained on the same, e.g. a voltage of at least 0.3 Volt.

Via a transistor circuit in the form of an FET circuit 5, this voltage is forwarded to the interrupt port 11 of the microcontroller 1. The FET circuit 5 serves to amplify the electrical signal obtained at the thermogenerator 2 and for this purpose includes a power source 52 (for example in the form of a battery) beside the FET 51. The presence of a voltage at the interrupt port 11 is detected by the switching means of the microcontroller and the same is switched from its inactive (first) state to the active (second) state.

It should be noted that in particular when using a microtechnologically produced thermogenerator the voltage generated by the thermogenerator can be so high that it can also be detected at the interrupt port 11 without the FET circuit. Thus, it is possible that the thermogenerator signal is directly supplied to the interrupt port 11 and an electronic editing circuitry is omitted. It is also conceivable to transform the voltage generated by the thermogenerator to a higher voltage, wherein in particular the transistor circuit and the power source 52 can be omitted, so that the thermogenerator operates in an energy-autarkical manner.

The thermogenerator 2 thus serves as manually operable thermal switch for activating the microcontroller 1. The switch principle illustrated in the FIGURE can of course also be combined with other electrically operable devices, for example with sockets or generally with electric circuits whose energy-saving first state is the off-state and which upon receipt of an electrical signal forwarded by the thermogenerator are closed, i.e. switched into the on-state.

The thermal switch with the components thermogenerator 2, copper plate 3 and heat sink 4 can also be utilized in this or a similar form to register an increase in temperature in the environment of this arrangement. In particular, the copper plate and the heat sink therefore are formed with greatly differing thermal capacities, so that in the case of a temperature change in the environment of the thermogenerator for example the copper plate reacts faster, i.e. heats up faster, than the heat sink.

With a fast change in temperature, which for example occurs in case of a fire, a temperature gradient thus is obtained across the thermogenerator 2, whereby an electric voltage is obtained at the same, which serves as control voltage for waking up an electrically operable device connected with the thermogenerator. Of course, the thermogenerator arrangement also can include more than one thermogenerator. Furthermore, for example, an individual thermogenerator also can control a plurality of electrical devices, for example a plurality of microcontrollers.

1-22. (canceled)

23. A thermogenerator arrangement, comprising
an electrically operable device;
switching means by means of which the device can be switched from a first, energy-saving state to a second, active state; and
at least one thermogenerator which generates an electrical signal when there is a temperature change in its environment, which electrical signal is forwarded to the switching means, wherein
the switching means are formed such that switching the device from the first state to the second state is effected in dependence on the electrical signal of the thermogenerator.

24. The thermogenerator arrangement according to claim 23, wherein a voltage source separate from the thermogenerator supplies the device with an operating voltage in the second, active state.

25. The thermogenerator arrangement according to claim 23, wherein in the second, active state the thermogenerator supplies the device with an operating voltage.

26. The thermogenerator arrangement according to claim 23, wherein the thermogenerator operates in an energy-autarkical manner.

27. The thermogenerator arrangement according to claim 23, wherein on its cold side the thermogenerator includes a first structure of a first thermal capacity and on its warm side a second structure of a second thermal capacity, which is different from the first thermal capacity.

28. The thermogenerator arrangement according to claim 27, wherein the first and/or the second structure includes a phase change material.

29. The thermogenerator arrangement according to claim 23, wherein the electrically operable device comprises a device for generating an alarm signal, an air pressure sensor, an air humidity sensor, at least one temperature sensor, at least one gas sensor and/or a microprocessor.

30. The thermogenerator arrangement according to claim 23, wherein the thermogenerator is thermally connected with a structure for laying on a hand portion and is formed such that it generates an electrical signal due to the temperature change occurring in the environment of the thermogenerator when laying the hand portion on the structure.

31. The thermogenerator arrangement according to claim 30, wherein the thermogenerator and the structure for laying on a hand portion are integrated into a door handle.

32. The thermogenerator arrangement according to claim 23, the thermogenerator, the switching means and the device are integrated into a common housing and/or arranged on a common carrier.

33. The thermogenerator arrangement according to claim 23, wherein the device is provided in the form of a danger detector, wherein the switching means switch the danger detector from the first, energy-saving state to the second, active state in dependence on an electrical signal of the thermogenerator.

34. The thermogenerator arrangement according to claim 33, wherein the danger detector includes a body sound sensor which in dependence on an electrical signal of the thermogenerator can be switched from the first, energy-saving state to the second, active state.

35. The thermogenerator arrangement according to claim 23, wherein the device comprises a fire detector, wherein the switching means switch the fire detector from the first state to the second state in dependence on an electrical signal of the thermogenerator.

36. The thermogenerator arrangement according to claim 23, wherein the device is formed as fire detector which in addition to the thermogenerator includes means for detecting a fire, wherein the switching means switch the means for detecting a fire from the first state to the second state in dependence on an electrical signal of the thermogenerator.

37. The thermogenerator arrangement according to claim 36, wherein the detector includes a smoke sensor and/or a fire gas sensor.

38. The thermogenerator arrangement according to claim 36, further comprising activating means which activate the means for detecting a fire at intervals, so that for detecting purposes the means carry out measurements at intervals, in order to check whether a fire exists.

39. The thermogenerator arrangement according to claim 38, wherein the activating means activate the means for detecting a fire at intervals such that the distance between two triggered measurements is at least 5 seconds.

40. The thermogenerator arrangement according to claim 23, further comprising an electronic circuit which amplifies the electrical signal generated by the thermogenerator.

41. The thermogenerator arrangement according to claim 23, wherein the thermogenerator is produced microtechnologically.

42. A method for operating an electrical device, with the following steps:
providing a thermogenerator which generates an electrical signal when there is a temperature change in its environment;
switching the electrical device into a first, energy-saving state;
switching the electrical device from the first state to a second, active state in dependence on an electrical signal of the thermogenerator.
